(19) United States
(12) Patent Application Publication
(10) Pub. No.: US 2026/0213590 A1
(43) Pub. Date: Jul. 23, 2026

(54) ELECTRIC AXIAL FLUX MACHINE

(71) Applicant: Schaeffler Technologies AG & Co. KG, Herzogenaurach (DE)

(72) Inventors: Christian Dinger, Achern (DE); Aurelie Keller, Herrlisheim (FR); Stephan Maienschein, Baden-Baden (DE)

(21) Appl. No.: 19/140,834

(22) PCT Filed: Oct. 19, 2023
(86) PCT No.: PCT/DE2023/100779

§ 371 Date: Jun. 18, 2025

(30) Foreign Application Priority Data
Dec. 19, 2022 (DE) 10 2022 133 850.9

(51) Int. Cl. H02K 1/18; H02K 5/20; H02K 21/24

(52) U.S. Cl. CPC H02K 1/182; H02K 5/203; H02K 21/24

(57) ABSTRACT

An electric flux machine for use within a drive train of a hybrid or fully electrically driven motor vehicle includes a stator and a rotor separated from the stator by an air gap, wherein the stator is accommodated in a pot-like annular housing having a housing base extending in the radial direction, wherein the housing base extends through the air gap between the stator and the rotor and the housing is closed by a housing cover on the side axially opposite the housing base, wherein the housing cover has at least one first positioning means projecting in the axial direction out of the housing cover or projecting in the axial direction into the housing cover, which first positioning means co-operates with a corresponding second positioning means on the stator in such a way that the position of the stator is fixed relative to the housing cover.

### CROSS-REFERENCE TO RELATED APPLICATION

The present application is the U.S. National Phase of PCT Patent Application Number PCT/DE2023/100779, filed on Oct. 19, 2023, which claims priority to German Patent Application Number 10 2022 133 850.9, filed Dec. 19, 2022, the entire disclosures of which are incorporated by reference herein.

### TECHNICAL FIELD

The present disclosure relates to an electric axial flux machine, in particular for use within a drive train of a hybrid or fully electrically powered motor vehicle, comprising a stator and a rotor separated from the stator by an air gap.

### BACKGROUND

Electric motors are increasingly being used to power motor vehicles to create alternatives to combustion engines that require fossil fuels. Considerable efforts have already been made to improve the suitability of electric drives for everyday use and also to offer users the usual driving comfort.

A detailed description of an electric drive can be found in an article in the magazine ATZ, volume 113 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly integrative and flexible electric drive unit for electric vehicles], which is probably the next state of the art. This article describes a drive unit for a vehicle axle which comprises an electric motor arranged to be coaxial to a bevel gear differential. Such drive units are also known as E-axles or electrically operable drive trains.

Axial flux machines are also increasingly being used in such E-axes. An axial flux machine is a dynamoelectric machine in which the magnetic flux between the rotor and stator runs parallel to the axis of rotation of the rotor. Both the stator and rotor are often substantially disk-shaped. Axial flux machines are particularly advantageous when the axial installation space available in a given application is limited. This is often the case, for example, with the two electric drive systems for electric vehicles described above. In addition to the shortened axial length, another advantage of the axial flux machine is its comparatively high torque density. The reason for this is the larger air gap area available in a given installation space compared to radial flow machines. Furthermore, a smaller iron volume is required compared to conventional machines, which has a positive effect on the efficiency of the machine.

Thanks to its disk-shaped main assemblies, an axial flux machine is particularly suitable for applications where a very short overall length of the electric motor is required and where a relatively large motor diameter is still acceptable. When developing corresponding axial flux machines, it is therefore generally advisable to aim for the shortest possible design, wherein the outer diameter of the axial flux machine should however not be larger than absolutely necessary. In the case of axial flux machines for motor vehicles, there are always additional requirements for low weight, high power density and low costs.

### SUMMARY

It is therefore the object of the disclosure to provide an electric axial flux machine that is inexpensive to manufacture and easy to install.

This object is attained by an electric axial flux machine, in particular for use within a drive train of a hybrid or fully electrically driven motor vehicle, comprising a stator and a rotor separated from the stator by an air gap, wherein the stator is accommodated in a pot-like annular housing with a housing base extending in the radial direction, wherein the housing base extends through the air gap between the stator and rotor and the housing is closed by a housing cover on the side axially opposite the housing base, wherein the housing cover has at least one first positioning means projecting in the axial direction out of the housing cover or at least one first positioning means projecting in the axial direction into the housing cover, which co-operates with a corresponding second positioning means on the stator in such a way that the position of the stator is fixed relative to the housing cover, and/or the housing cover has at least one third positioning means projecting out of the housing cover in the axial direction or at least one third positioning means projecting into the housing cover in the axial direction, which interacts with a corresponding fourth positioning means on the housing in such a way that the position of the housing relative to the housing cover is fixed.

This has the advantage that components of the axial flux machine can be positioned in relation to each other directly via these components themselves, which in particular enables shorter tolerance chains and consequently more efficient utilization of installation space. For this purpose, the stator and housing are positioned directly via the corresponding positioning means, which are designed, for example, as moldings or protrusions on the housing cover. The tolerance chains between stator and housing cover as well as between housing and stator or housing cover can be kept as short as possible by this measure. No further assembly aids are required in the tool, which can also have a positive effect on ease of assembly and manufacturing costs.

First, the individual elements of the claimed subject matter of the disclosure are explained in the order in which they are mentioned in the set of claims, and then particularly preferred embodiments of the subject matter of the disclosure are described.

The magnetic flux in an electric axial flux machine (AFM), such as an electric drive machine of a motor vehicle designed as an axial flux machine, is directed axially to a direction of rotation of the rotor of the axial flux machine in the air gap between the stator and rotor.

Depending on the application, it can be advantageous to design an axial flux machine in an I-arrangement or H-arrangement. In an I-arrangement, the rotor is arranged to be axially adjacent to a stator or between two stators. In an H-arrangement, two rotors are arranged on opposite axial sides of a stator. The axial flux machine according to the disclosure is preferably configured in an I-arrangement.

In principle, it is also possible for a plurality of rotor-stator configurations to be arranged to be axially adjacent to each other as I-type and/or H-type. In this context, it would also be possible to arrange several I-type rotor-stator configurations adjacent to each other in the axial direction. In particular, it is also preferable that the rotor-stator configuration of the H-type and/or the I-type are essentially identical in each case, so that they can be joined together in a modular fashion to form an overall configuration. Such rotor-stator configurations can in particular be arranged to be coaxial to each other and connected to a common rotor shaft or to several rotor shafts.

The stator of the electrical axial flux machine according to the disclosure preferably has a stator body with several stator windings arranged in the circumferential direction. The stator body can be in one piece or segmented when viewed in the circumferential direction. The stator body can be formed from a stator laminated core with several laminated electrical sheet steels. Alternatively, the stator body can also be made of a pressed soft magnetic material, such as what is termed the SMC (Soft Magnetic Compound) material.

The stator is housed in a casing. The housing can be designed in one or more parts. The housing is preferably made of plastic. The housing can be closed on all sides. It is also possible to provide openings in the housing, for example to reduce weight or for access to a component.

The rotor of an electric axial flux machine can be designed at least in part as a laminated rotor. A laminated rotor is layered in the axial direction. Alternatively, the rotor of an axial flux machine can also have a rotor carrier that is equipped with magnetic sheets and/or SMC material and with magnetic elements designed as permanent magnets.

The permanent magnets can preferably be inserted into the pockets of the laminated rotor core. A single larger rotor magnet designed as a bar magnet or several smaller rotor magnets designed as permanent magnet elements can be provided per pocket.

The rotor preferably has a plurality of rotor bodies. It is particularly preferred that the rotor bodies are essentially equal, in particular essentially identical. It is highly preferable for the rotor bodies to be formed from equal, in particular essentially identical, rotor laminations. The rotor bodies are therefore preferably formed from a laminated rotor core, which is composed of a plurality of laminated individual overlays or rotor laminations, usually made of electrical sheet steel, which are stacked and packaged on top of each other to form a stack, what is termed the laminated rotor core. The individual sheets can be held together in the laminated rotor core by gluing, welding, or screwing together. In particular, a laminated rotor core can also have permanent magnets inserted into the pockets of the laminated rotor core or fixed around the circumference of the laminated rotor core.

A rotor shaft is a rotatably mounted shaft of an electric machine to which the rotor or rotor body is coupled in a rotationally fixed manner.

The electric axial flux machine can also have a control device. A control device, such as can be used in the present disclosure, is used in particular for the electronic control and/or regulation of one or more technical systems of the electric axial flux machine.

The electric axial flux machine is intended in particular for use within a drive train of a hybrid or fully electrically powered motor vehicle. In particular, the electric motor is dimensioned so that vehicle speeds greater than 50 km/h, preferably greater than 80 km/h and in particular greater than 100 km/h can be achieved. It is particularly preferred that the electric motor has an output greater than 30 kW, preferably greater than 50 kW and in particular greater than 70 kW. It is also preferred that the electric machine provides speeds greater than 5,000 rpm, particularly preferably greater than 10,000 rpm, most preferably greater than 12,500 rpm.

The electric axial flux machine can preferably also be installed in an electrically operable axle drive train. An electric axle drive train of a motor vehicle comprises an electric axial flux machine and a transmission, wherein the electric axial flux machine and the transmission form a structural unit. In particular, it can be provided that the electric axial flux machine and the gearbox are arranged in a common drive train housing. In particular, such a drive train housing can also preferably form a connection structure for the axial flux machine. Alternatively, it would of course also be possible for the electric axial flux machine to have a motor housing and the gearbox to have a gearbox housing, wherein the structural unit can then be realized by fixing the gearbox in relation to the electric axial flux machine. This structural unit is sometimes also referred to as an E-axle.

According to an advantageous embodiment of the disclosure, it can be provided that the first positioning means and/or the third positioning means is formed integrally, in particular monolithically, with the housing cover. The advantage of this design is that it can further reduce manufacturing costs and also further improve ease of assembly.

According to a further preferred further development of the disclosure, it can also be provided that the first positioning means and/or the third positioning means are each designed as a component separate from the housing cover. Such a separate component can be a feather key, for example.

Furthermore, according to an equally advantageous embodiment of the disclosure, it can be provided that the separate component has a feed-through for at least one electrical conductor from the housing. The advantageous effect of this design is that a higher degree of system integration can be achieved by integrating a further function in the separate component, which can also contribute to simplified assembly and reduced manufacturing costs.

According to a further particularly preferred embodiment of the disclosure, it can be provided that the first positioning means and the third positioning means are designed in one piece, which can also have a positive influence on the manufacturing costs.

Furthermore, the disclosure can also be further developed in such a way that the second positioner means is designed as a recess extending axially into the stator. The advantage of this design is that such a recess can be realized comparatively easily in a stator, which can again contribute to a cost-effective production of the axial flux machine.

In an equally preferred embodiment of the disclosure, it can also be provided that the housing cover has a cylinder ring section extending in the axial direction towards the rotor, on which at least one fifth positioning means projecting in the radial direction into the cylinder ring section or extending out of the cylinder ring section is provided, which interacts with a corresponding sixth positioner means on the housing in such a way that the position of the housing relative to the housing cover is fixed. This can also provide a favorable variant for positioning the components in relation to each other in terms of production technology.

It can also be advantageous to further develop the disclosure in such a way that the fifth positioning means is formed in one piece, in particular monolithically with the cylinder ring section, which can again provide production-related advantages. According to a further preferred embodiment of the object of the disclosure, however, it can also be provided that the fifth positioning means is designed as a component separate from the cylinder ring section, for example as a feather key.

Finally, the disclosure can also be advantageously implemented in such a way that the axial flux machine is configured in an I-arrangement.

In the following, the disclosure will be explained in more detail with reference to figures without limiting the general idea of the disclosure.

### BRIEF DESCRIPTION OF THE DRAWINGS

In the figures:

FIG. 1 shows a schematic axial sectional view of an electric axial flux machine,

FIG. 2 shows a first embodiment of a stator of an electric axial flux machine in a schematic axial sectional view,

FIG. 3 shows a second embodiment of a stator of an electric axial flux machine in a schematic axial sectional view,

FIG. 4 shows a third embodiment of a stator of an electric axial flux machine in a schematic axial sectional view,

FIG. 5 shows a fourth embodiment of a stator of an electric axial flux machine in a schematic axial sectional view,

FIG. 6 shows a fifth embodiment of a stator of an electric axial flux machine in a schematic axial sectional view,

FIG. 7 shows a sixth embodiment of a stator of an electric axial flux machine in a schematic axial sectional view,

FIG. 8 shows a seventh embodiment of a stator of an electric axial flux machine in a schematic axial sectional view and a stator body in a perspective view,

FIG. 9 shows an eighth embodiment of a stator of an electric axial flux machine in a schematic axial sectional view,

FIG. 10 shows a ninth embodiment of a stator of an electric axial flux machine in a schematic axial sectional and a cross-sectional view,

FIG. 11 shows a tenth embodiment of a stator of an electric axial flux machine in a schematic axial sectional view and a cross-sectional view,

FIG. 12 shows an eleventh embodiment of a stator of an electric axial flux machine in a schematic axial sectional view,

FIG. 13 shows a twelfth embodiment of a stator of an electric axial flux machine in a schematic axial sectional view,

FIG. 14 shows a thirteenth embodiment of a stator of an electric axial flux machine in a schematic axial sectional view,

FIG. 15 shows a fourteenth embodiment of a stator of an electric axial flux machine in a schematic axial sectional view.

### DETAILED DESCRIPTION

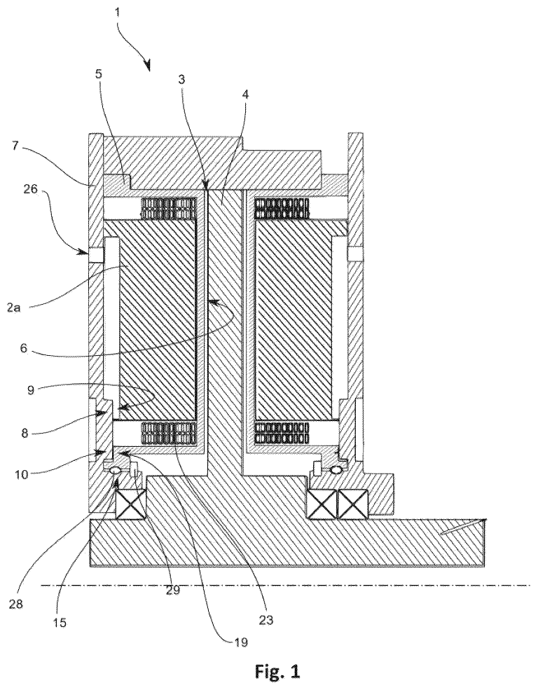

FIG. 1 shows an electric axial flux machine 1, in particular for use within a drive train of a hybrid or fully electrically powered motor vehicle, comprising a stator 2 with a stator winding 23 and a rotor 4 separated from the stator 2 by an air gap 3. The axial flux machine 1 is configured in an I-arrangement, so that the axial flux machine 1 is a mirror image of the radial plane of the rotor 4. For reasons of clarity, no reference symbols are used for the right-hand stator. It is understood, however, that this is essentially a mirror image of the left-hand stator 2.

The stator 2 is accommodated in a pot-like annular housing 5 with a housing base 6 extending in the radial direction, wherein the housing base 6 extends through the air gap 3 between the stator 2 and rotor 4 and the housing 5 is closed by a housing cover 7 on the side axially opposite the housing base 6. The housing 5 is therefore reminiscent of the shape of a donut.

The housing 5 is sealed against the housing cover 7 by the sealing ring 28 and axially secured by the securing ring 29.

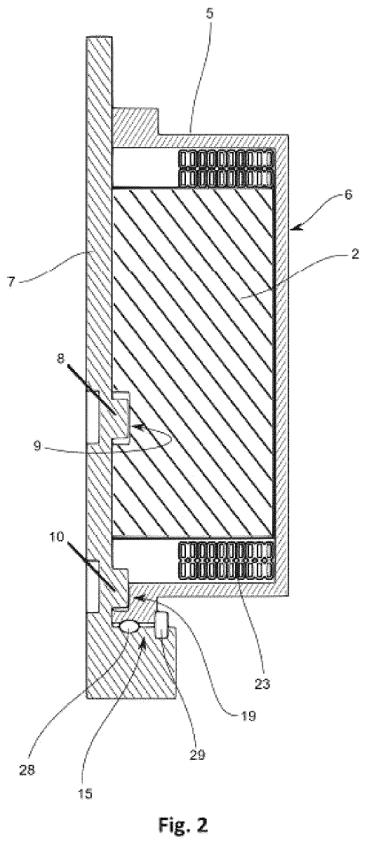

The housing cover 7 has at least one first positioning means 8 projecting out of the housing cover 7 in the axial direction or projecting into the housing cover 7 in the axial direction, which interacts with a corresponding second positioning means 9 on the stator 2 in such a way that the position of the stator 2 is fixed relative to the housing cover 7. Furthermore, the housing cover 7 can have at least one third positioning means 10 projecting out of the housing cover 7 in the axial direction or projecting into the housing cover 7 in the axial direction, which interacts with a corresponding fourth positioning means 9 on the housing 5 in such a way that the position of the housing 5 relative to the housing cover 7 is fixed. This results in a number of configuration options, which are explained in more detail below using FIGS. 2-11.

FIG. 2 shows an embodiment in which the first positioning means 8 and the third positioning means 10 are each formed in one piece, in particular monolithically, with the housing cover 7, and protrude axially from the housing cover 7. The positioner means 8, 10 can be formed by means of staking, for example. As a result, the positioner means 8, 10 have a pin-like design, wherein the first positioner means 8 engages in a corresponding recess (second positioner means 9) of the stator 2 and the second positioner means 10 engages in a corresponding recess (fourth positioner means 19) of the housing 5 formed on the radially inner circumference of the housing 5. To also achieve a centering of the components in relation to one another, it is recommended to form at least three pin-like positioner means 8, 10 on the circumference of the housing cover 7. If there is a centering, e.g., via a centering diameter, a pin-like positioner means 8, 10 is sufficient for the circumferential positioning of the corresponding component.

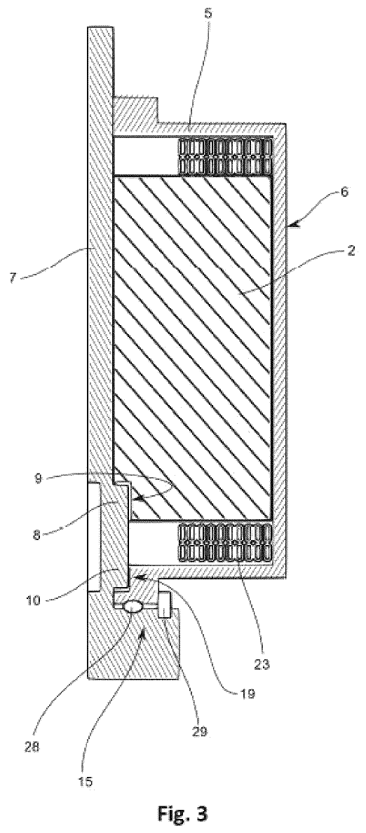

FIG. 3 shows a slightly modified embodiment of FIG. 2, in which the first positioning means 8 and the third positioning means 10 are designed in one piece and positioned in the radially inner circumferential area of the housing 5. The one-piece positioner means 8, 10 is also formed monolithically from the housing cover 7 by means of staking.

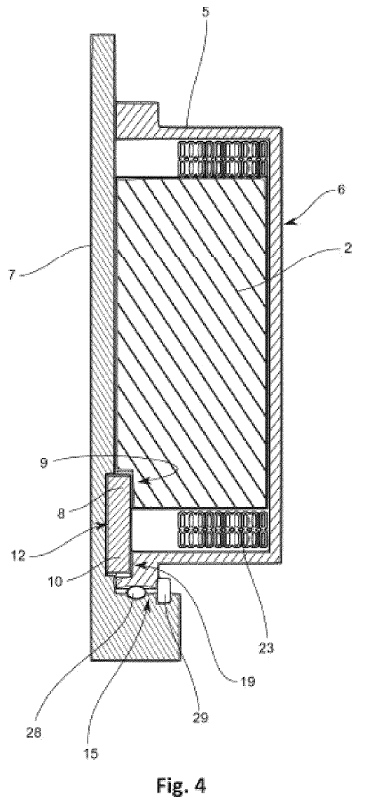

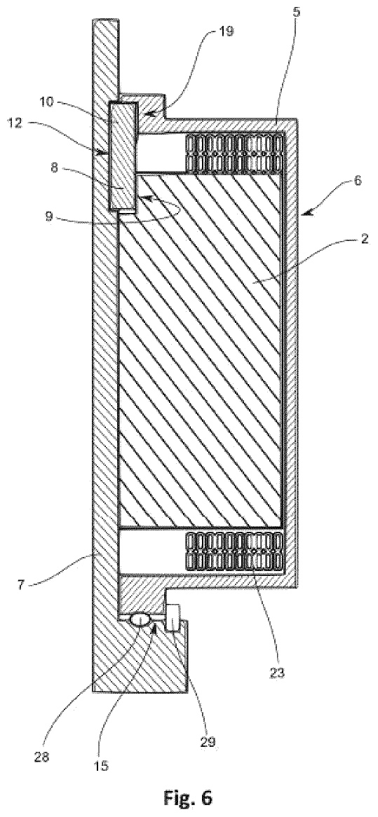

A modification of the solution known from FIG. 3 is shown in FIG. 4. In this case, the first positioning means 8 and the third positioning means 10 are designed together but as a separate component 12 from the housing cover 7. The separate component 12 is a feather key and is positioned in the radially inner area of the housing 5. Positioning on the radially outer area of the housing 5 is also possible, as shown in FIG. 6.

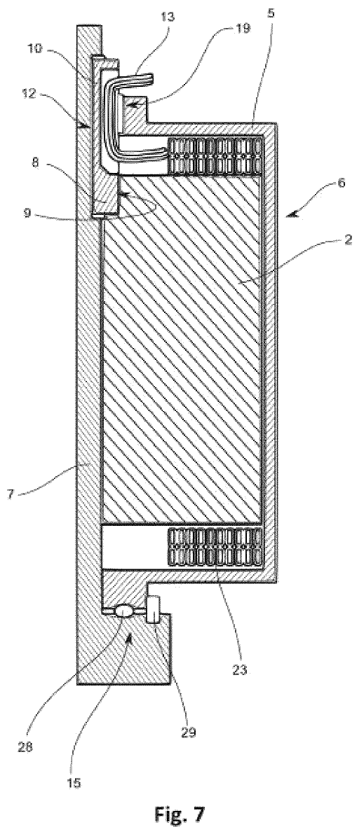

As can be seen in FIG. 7, in this embodiment the separate component 12 has a feed-through 14 for at least one electrical conductor 13 from the housing 5, wherein the electrical conductor 13 is provided for energizing the stator winding 23.

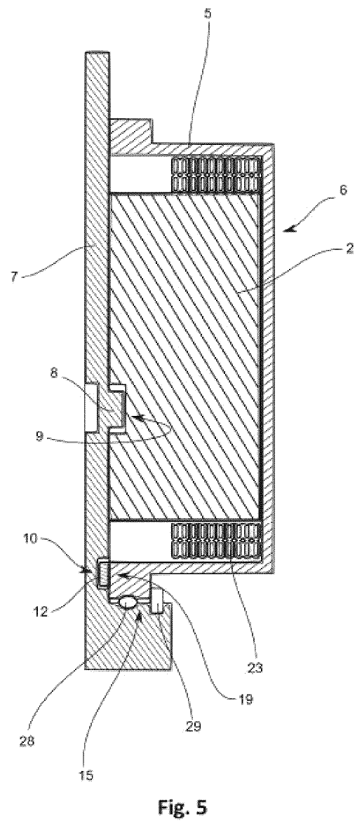

FIG. 5 shows a slight modification of the embodiment already known from FIG. 2. Here, however, the third positioning means 10 is designed as a recess in which a separate component 12 designed as a feather key engages and positions the housing 5 relative to the housing cover 7. It is of course also possible for the separate component 12 to be made in one piece with the housing 5 and then engage in the corresponding recess of the housing cover 7 as a pin-like positioning means 19.

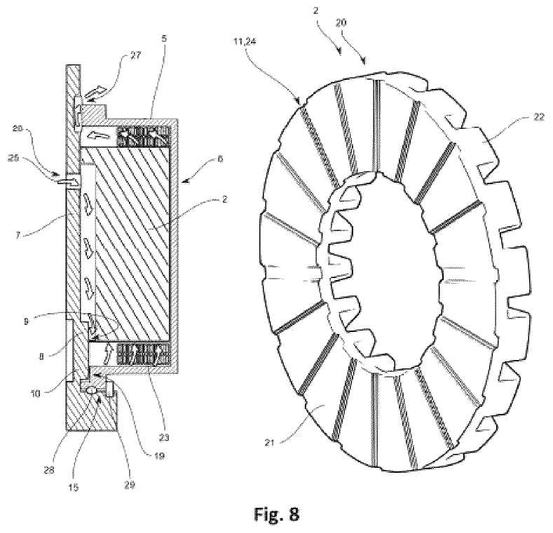

FIG. 8 shows an alternative design in which the second positioner means 9 is designed as a recess 11 extending axially into the stator 2. On the side of the stator 2 facing the housing cover 7, a large number of such recesses 11 can run in a radial direction through the annular disk-like stator yoke 21 of the stator body 20, which act as cooling channels 24. The stator body 20 also has stator teeth 22 extending out of the stator yoke 21 in the axial direction. The cooling channels 24 can therefore now be used to provide a recess 11 in the stator 2 into which the first positioning means 8 engages. The recess 11 then forms the second positioning means 9. With a stator 2 wound from a sheet metal strip, it makes sense to support the position between the housing cover 7 and stator 2 as far radially inwards as possible, as the wound stator 2 has the highest accuracy in this area.

The cooling fluid 25 can thus be fed through the housing cover 7 via a cooling fluid inlet 26 and supplied to the cooling channels 24. The cooling fluid 25 then leaves the stator area again through the outlet opening 27 in the radially upper area of the housing 5.

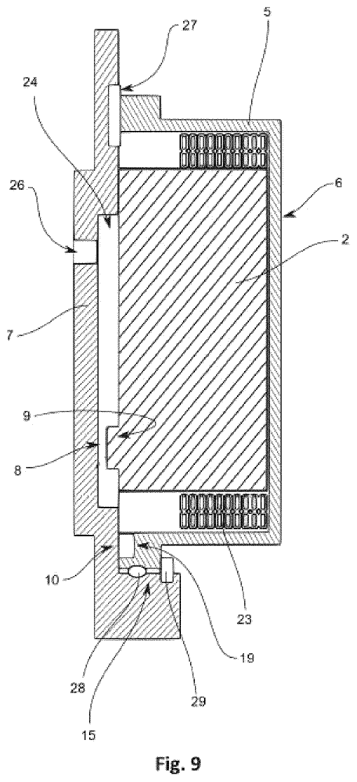

The embodiment in FIG. 9 essentially corresponds to that in FIG. 8, with the difference that the cooling channel is molded into the housing cover 7. A pin-like positioning means 9 for positioning is then provided on the stator 2, which engages in the cooling channel of the housing cover 7. The cooling channel 24 thus represents the first positioning means 8 of the housing cover 7.

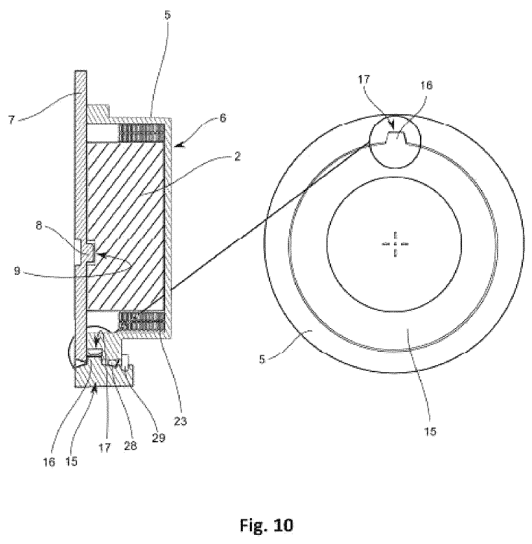

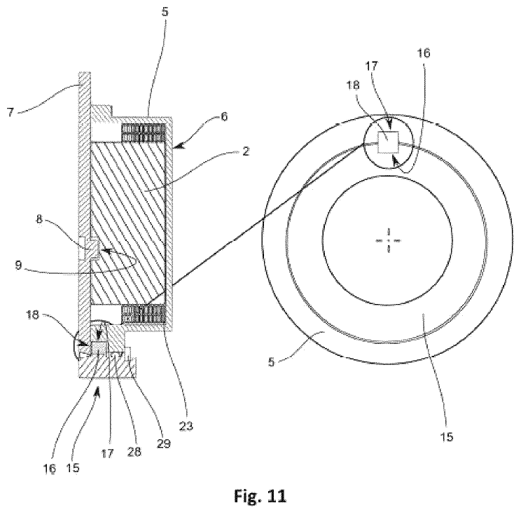

FIGS. 10-11 show two embodiments in which the housing cover 7 has a cylindrical ring section 15 extending in the axial direction towards the rotor 4, on which at least one fifth positioning means 16 projecting in the radial direction into the cylindrical ring section 15 or extending out of the cylindrical ring section 15 is formed, which interacts with a corresponding sixth positioner means 17 on the housing 5 in such a way that the position of the housing 5 relative to the housing cover 7 is fixed. FIG. 10 shows an embodiment in which the fifth positioning means 16 is formed in one piece, in particular monolithically with the cylinder ring section 15. The positioning of the housing 5 can therefore take place, for example, via a plug-in toothing (positive fit) on the cylinder ring section 15. As can be seen from the figures, the axial flux machine 1 in the embodiment shown has a housing cover 7 and a hub connected to the housing cover 7 via a welded joint, which forms the cylinder ring section 15. If the housing cover 7 is centered over a diameter, a tooth-like positioning means 16 is sufficient to maintain the circumferential position, as shown in FIG. 10. Otherwise, at least three tooth-like positioning means 16 are required to additionally center the housing 5.

In the embodiment shown in FIG. 11, the fifth positioning means 16 is designed as a component 18 separate from the cylinder ring section 15, for example as a feather key.

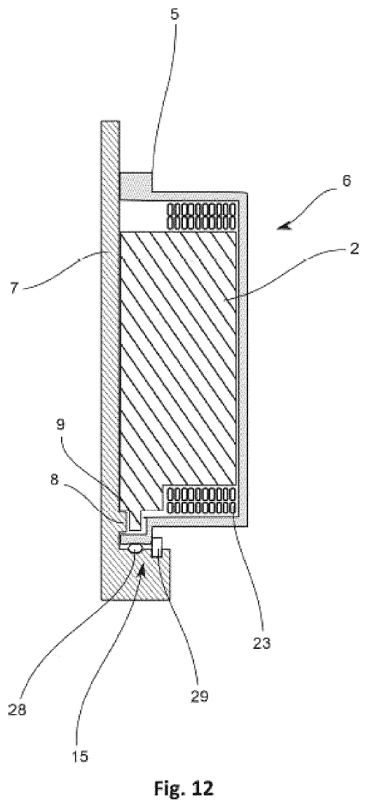

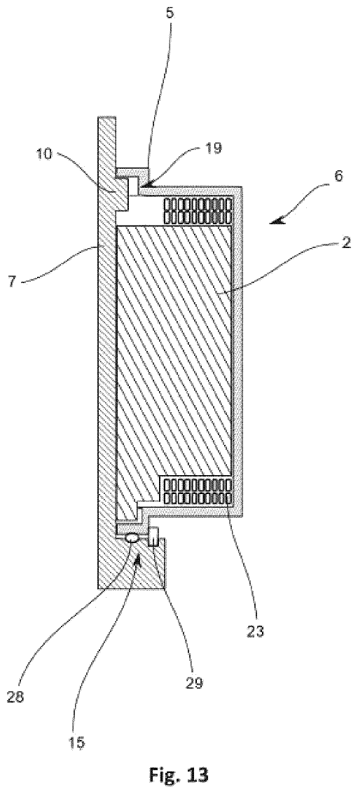

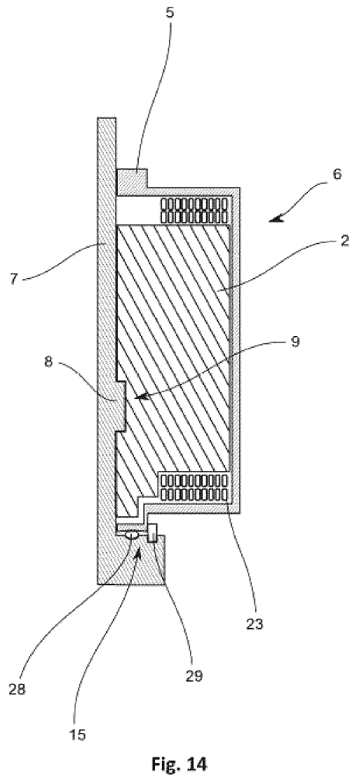

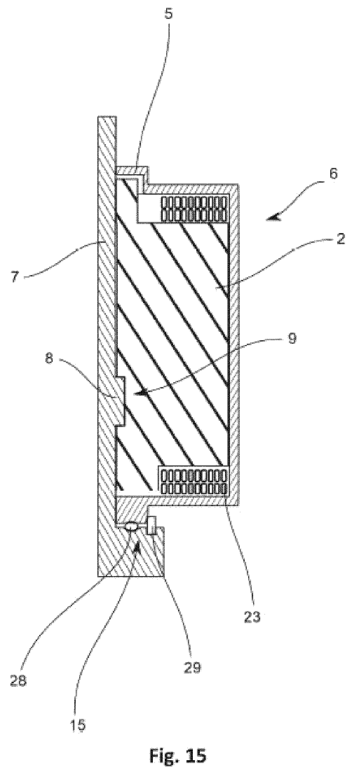

FIGS. 12-15 show further embodiments of the disclosure in which the housing base 6 and/or the housing cover 7 are also positioned over the stator 2. Otherwise, these embodiments correspond to those known from FIGS. 2-7.

The disclosure is not limited to the embodiments shown in the figures. The above description should therefore be regarded as explanatory rather than restrictive. The following claims are to be understood as meaning that a said feature is present in at least one embodiment of the disclosure. This does not exclude the presence of other characteristics. Where the patent claims and the above description define ‘first’ and ‘second’ features, this designation serves to distinguish between two similar features without establishing an order of priority.

### LIST OF REFERENCE SYMBOLS

1 Axial flux machine
2 Stator
3 Air gap
4 Rotor
5 Housing
6 Housing base
7 Housing cover
8 Positioning means
9 Positioning means
10 Positioning means
11 Recess
12 Component
13 Conductor
14 Feed-through
15 Cylinder ring section
16 Positioning means
17 Positioner means
18 Component
19 Positioning means
20 Stator body
21 Stator yoke
22 Stator teeth
23 Stator winding
24 Cooling channels
25 Cooling fluid
26 Cooling fluid inlet
27 Cooling fluid outlet
28 Sealing ring
29 Securing ring

1. An electric axial flux machine for use within a drive train of a hybrid or fully electrically powered motor vehicle, the electric axial flux machine comprising:
a stator and a rotor separated from the stator by an air gap,
the stator accommodated in an annular housing with a housing base extending in the radial direction, wherein the housing base extends through the air gap between the stator and rotor and the housing is closed on the side axially opposite the housing base by a housing cover,
the housing cover having at least one first positioning means projecting out of the housing cover in the axial direction or projecting into the housing cover in the axial direction, which interacts with a corresponding second positioning means on the stator in such a way that the position of the stator relative to the housing cover is fixed,
the housing cover having at least one third positioning means projecting in the axial direction out of the housing cover or projecting in the axial direction into the housing cover, which interacts with a corresponding fourth positioning means on the housing in such a way that the position of the housing is fixed relative to the housing cover.

2. The axial flux machine according to claim 1, wherein the first positioning means and/or the third positioning means is formed in one piece, in particular monolithically, with the housing cover.

3. The axial flux machine according to claim 1, wherein the first positioning means and/or the third positioning means each comprise a separate component separate from the housing cover.

4. The axial flux machine according to claim 3, wherein the separate component has a feed-through for at least one electrical conductor from the housing.

5. The axial flux machine according to claim 1, wherein the first positioning means and the third positioning means are designed in one piece.

6. The axial flux machine according to claim 1, wherein the second positioner means is designed as a recess extending axially into the stator.

7. The axial flux machine according to claim 1, wherein the housing cover has a cylindrical ring section which extends in the axial direction towards the rotor and on which at least one fifth positioning means projects into the cylindrical ring section in the radial direction or extends out of the cylindrical ring section, and which interacts with a corresponding sixth positioner means on the housing such that the position of the housing relative to the housing cover is fixed.

8. The axial flux machine according to claim 7, wherein the fifth positioning means is formed in one piece, in particular monolithically with the cylinder ring section.

9. The axial flux machine according to claim 7, wherein the fifth positioning means is designed as a component separate from the cylinder ring section.

10. The axial flux machine according to claim 1, wherein the axial flux machine is configured in an I-arrangement.

11. An electric axial flux machine comprising:
a stator and a rotor separated from the stator by an air gap,
wherein the stator is accommodated in an annular housing with a housing base extending in the radial direction, wherein the housing base extends through the air gap between the stator and rotor and the housing is closed on the side axially opposite the housing base by a housing cover,
wherein the housing cover has at least one first positioning means projecting out of the housing cover in the axial direction or projecting into the housing cover in the axial direction, which interacts with a corresponding second positioning means on the stator in such a way that the position of the stator relative to the housing cover is fixed,
wherein the housing cover has at least one third positioning means projecting in the axial direction out of the housing cover or projecting in the axial direction into the housing cover, which interacts with a corresponding fourth positioning means on the housing in such a way that the position of the housing is fixed relative to the housing cover,
wherein the first positioning means and the third positioning means are formed in a monolithic piece with the housing cover and the second positioner means comprises a recess extending axially into the stator.

12. The axial flux machine according to claim 11, wherein the housing cover has a cylindrical ring section extending in the axial direction towards the rotor and on which at least one fifth positioning means projects into the cylindrical ring section in the radial direction or extends out of the cylindrical ring section, and which interacts with a corresponding sixth positioner means on the housing such that the position of the housing relative to the housing cover is fixed.

13. The axial flux machine according to claim 12, wherein the fifth positioning means is formed in one monolithic piece with the cylinder ring section.

14. The axial flux machine according to claim 12, wherein the fifth positioning means comprises a separate component separate from the cylinder ring section.

15. The axial flux machine according to claim 11, wherein the axial flux machine is configured in an I-arrangement.

16. A drivetrain comprising:
an axial flux machine, the axial flux machine comprising:
a stator; and
a rotor separated from the stator by an air gap,
wherein the stator is accommodated in an annular housing with a housing base extending in the radial direction, wherein the housing base extends through the air gap between the stator and rotor and the housing is closed on the side axially opposite the housing base by a housing cover,
wherein the housing cover has at least one first positioning means projecting out of the housing cover in the axial direction or projecting into the housing cover in the axial direction, which interacts with a corresponding second positioning means on the stator in such a way that the position of the stator relative to the housing cover is fixed,
wherein the housing cover has at least one third positioning means projecting in the axial direction out of the housing cover or projecting in the axial direction into the housing cover, which interacts with a corresponding fourth positioning means on the housing in such a way that the position of the housing is fixed relative to the housing cover.

17. The drivetrain according to claim 16, wherein the first positioning means and the third positioning means are formed in one monolithic piece with the housing cover.

18. The drivetrain according to claim 16, wherein the first positioning means and the third positioning means each comprise a separate component separate from the housing cover.

19. The drivetrain according to claim 18, wherein the separate component has a feed-through for at least one electrical conductor from the housing.

20. The drivetrain according to claim 16, wherein the first positioning means and the third positioning means are designed in one piece.
